(19) United States
(12) Patent Application Publication
(10) Pub. No.: US 2020/0380555 A1
(43) Pub. Date: Dec. 3, 2020

(54) METHOD AND APPARATUS FOR OPTIMIZING ADVERTISEMENT CLICK-THROUGH RATE ESTIMATION MODEL

(71) Applicant: Baidu Online Network Technology (Beijing) Co., Ltd., Beijing (CN)

(72) Inventors: Miao Fan, Beijing (CN); Jiacheng Guo, Beijing (CN); Lin Liu, Beijing (CN); Lian Zhao, Beijing (CN); Yue Wang, Beijing (CN); Mingming Sun, Beijing (CN); Ping Li, Beijing (CN); Haifeng Wang, Beijing (CN)

(21) Appl. No.: 16/883,076

(22) Filed: May 26, 2020

(30) Foreign Application Priority Data
May 30, 2019 (CN) 201910467690.4

(51) Int. Cl. G06Q 30/02; G06K 9/62

(52) U.S. Cl. CPC G06Q 30/0244; G06Q 30/0276; G06K 9/6223; G06Q 30/0246

(57) ABSTRACT

A method and apparatus for optimizing an Ad CTR estimation model are provided. The method includes: calculating a direction vector and a step vector based on data in a training set, wherein the direction vector and the step vector are associated with a first parameter vector, and the first parameter vector is a parameter vector of the Ad CTR prediction model; calculating an optimized first parameter vector by setting the first parameter vector, the direction vector and the step vector as inputs of an update function, and by using a second parameter vector, wherein the second parameter vector is a parameter vector of the update function; estimating an optimized second parameter vector according to an optimization target in a validation set, the optimization target is determined by using the optimized first parameter vector; updating the optimized first parameter vector by using the optimized second parameter vector.

### CROSS-REFERENCE TO RELATED APPLICATION

This application claims priority to Chinese Patent Application No.2019104676904, filed on May 30, 2019, which is hereby incorporated by reference in its entirety.

### TECHNICAL FIELD

The present application relates to a field of machine learning technology, and in particular, to a method and apparatus for optimizing an Advertisement Click-Through Rate (Ad CTR) estimation model.

### BACKGROUND

Currently, a core of entire Internet advertising industry is to estimate an Ad CTR by using an Ad CTR estimation model. A method for selecting an advertisement for an Internet user, and a method for distributing and displaying the advertisement to the user may be selected to maximize a possibility for clicking the displayed advertisement by the user. Those methods may not only show the ability and efficiency of an Internet advertising platform in monetizing user traffic, but also directly affect the platform's revenue in Internet advertising.

### SUMMARY

A method and apparatus for optimizing an Ad CTR estimation model are provided according to embodiments of the present application, so as to at least solve the above technical problems in the existing technology

In a first aspect, a method for optimizing an Ad CTR estimation model is provided according to an embodiment of present application. The method includes: calculating a direction vector and a step vector based on data in a training set, wherein both of the direction vector and the step vector are associated with a first parameter vector, and the first parameter vector is a parameter vector of the Ad CTR estimation model; calculating an optimized first parameter vector by setting the first parameter vector, the direction vector and the step vector as inputs of an update function, and by using a second parameter vector, wherein the second parameter vector is a parameter vector of the update function; estimating an optimized second parameter vector according to an optimization target in a validation set, wherein the optimization target is determined by using the optimized first parameter vector; and updating the optimized first parameter vector by using the optimized second parameter vector.

In an implementation, the calculating a direction vector and a step vector based on data in a training set, including:

calculating elements of the direction vector with a following formula, and forming the direction vector by the calculated elements;

$$d ( {w}_{i}^{t} ) = log \frac{α + click ( {x}_{i} )}{α + predict ( {x}_{i} )} ,$$

wherein

(wᵢ^{t}) represents an i-th element of the direction vector in a t-th round optimization;

α is a positive number larger than 0 and less than 1;

xᵢ represents an i-th feature of a feature vector of the Ad CTR estimation model;

click(xᵢ) represents an actual click number of the xᵢ in the training set; and

predict(xᵢ) represents an estimated click number of the xᵢ.

In an implementation, the calculating a direction vector and a step vector based on data in a training set, including:

calculating elements of the step vector with a following formula, and forming the step vector by the calculated elements;

s(wᵢ^{t})=log(β+impression(xᵢ), wherein

s(wᵢ^{t}) represents an i-th element of the step vector in a t-th round optimization;

β is a positive number larger than 0 and less than 1;

xᵢ represents an i-th feature of a feature vector of the Ad CTR estimation model; and impression(xᵢ) represents a number of times that the xᵢ is presented in the training set.

In an implementation, the update function is defined by a following formula:

w^{t+1}=F(w^{t}, d(w^{t}), s(w^{t})), wherein

w^{t+1} represents the optimized first parameter vector in a t-th round optimization;

w^{t} represents the first parameter vector in the t-th round optimization;

d(w^{t}) represents the direction vector associated with the w^{t} in the t-th round optimization; and

s(w^{t}) represents the step vector associated with the w^{t} in the t-th round optimization.

In an implementation, the w^{t+1} the w is determined by:

calculating element of the w^{t+1} with a following formula, and forming the w^{t+1} by the calculated elements;

w_{j,m}^{t+1}<F(w_{j,m}^{t}, d(w_{j,m}^{t}))=w_{j,m}^{t}+uⱼ·vⱼ, wherein

w_{j,m}^{t+1} represents an m-th element in a j-th slot of w^{t+1};

w_{j,m}^{t} represents an m-th element in a j-th slot of w^{t};

d(w_{j,m}^{t}) represents an m-th element in a j-th slot of d(w^{t}:

s(w_{j,m}^{t}) represents an m-th element in a j-th slot of s(w^{t});

uⱼ represents a vector associated with a j-th slot in the second parameter vector; and

vⱼ represents an eigenvector of a j-th slot.

In an implementation, the vⱼ is determined by:

representing each element associated with a j-th slot in the first parameter vector by a three-dimensional vector (w_{j,m}^{t}, d(w_{j,m}^{t}), s(w_{j,m}^{t}), wherein m is an index of the element in the j-th slot;

performing a clustering on the three-dimensional vector of the element associated with the j-th slot via a K-means algorithm, to obtain 1 central points for the j-th slot, wherein the 1 is an integer;

calculating reciprocals of the distances between the three-dimensional vector of the element associated with the j-th slot and the 1 central points for the j-th slot respectively, and setting the reciprocals as elements of the vⱼ; and

forming the vⱼ by the elements.

In an implementation, the vⱼ is determined by:

representing a j-th slot of the first parameter vector by a set of three-dimensional vectors (wⱼ^{t}, d(wⱼ^{t}), s(wⱼ^{t})), wherein the wⱼ^{t} is a vector associated with a j-th slot of the w^{t}, the d(wⱼ^{t}) is a vector associated with a j-th slot of the d(w^{t}) and the s(wⱼ^{t}) is a vector associated with a j-th slot of the s(w^{t}); and

re-representing the set of three-dimensional vectors through a Gauss mixture model, and estimating the vⱼ in a maximum expectation algorithm.

In an implementation, the training set and the validation set are determined by:

dividing dynamically streaming data with a sliding window, to obtain the training set and the verification set.

In a second aspect, an apparatus for optimizing an Ad CTR estimation model is provided according to an embodiment of the present application. The apparatus includes:

a calculation module, configured to calculate a direction vector and a step vector based on data in a training set, wherein both of the direction vector and the step vector are associated with a first parameter vector, and the first parameter vector is a parameter vector of the Ad CTR estimation model;

an optimization module, configured to calculate an optimized first parameter vector by setting the first parameter vector, the direction vector and the step vector as inputs of an update function, and by using a second parameter vector, wherein the second parameter vector is a parameter vector of the update function;

a validation module, configured to estimate an optimized second parameter vector according to an optimization target in a validation set, wherein the optimization target is determined by using the optimized first parameter vector; and

an update module, configured to update the optimized first parameter vector by using the optimized second parameter vector.

In an implementation; the calculation module is configured to:

calculate elements of the direction vector with a following formula, and form the direction vector by the calculated. elements;

$$d ( {w}_{i}^{t} ) = log \frac{α + click ( {x}_{i} )}{α + predict ( {x}_{i} )} ,$$

wherein

d(wᵢ^{t}) represents an i-th element of the direction vector in a t-th round optimization;

α is a positive number larger than 0 and less than 1;

xᵢ represents an i-th feature of a feature vector of the Ad CTR estimation model;

click(xᵢ) represents an actual click number of the xᵢ in the training set; and

predict(xᵢ) represents an estimated click number of the xᵢ.

In an implementation, the calculation module is configured to:

calculate elements of the step vector with a following formula, and form the step vector by the calculated elements;

s(wᵢ^{t})=log(β+impression (xᵢ)), wherein

s(wᵢ^{t}) represents an i-th element of the step vector in a t-th round optimization;

β is a positive number larger than 0 and less than 1;

xᵢ represents an i-th feature of a feature vector of the Ad CTR estimation model; and

impression (xᵢ) represents a number of times that the xᵢ is presented in the training set.

In an implementation, the update function is defined by a following formula:

w^{t+1}=F(w^{t}, d(w^{t}), s(w^{t}), wherein

w^{t+1} represents the optimized first parameter vector in a t-th round optimization;

w^{t} represents the first parameter vector in the t-th round optimization;

d(w^{t}) represents the direction vector associated with the w^{t} in the t-th round optimization; and

s(w^{t}) represents the step vector associated with the w^{t} in the t-th round optimization.

In an implementation, the optimization module is configured to calculate elements of the w^{t+1} with a following formula, and forming the w^{t+1} by the calculated elements;

w_{j,m}^{t+1}=F(w_{j,m}^{t}, d(w_{j,m}^{t}),s(w_{j,m}^{t}))=w_{j,m}^{t}+uⱼ·vⱼ, wherein

w_{j,m}^{t+1} represents an m-th element in a j-th slot of w^{t+1};

w_{j,m}^{t} represents an m-th element in a j-th slot of w^{t};

d(w_{j,m}^{t}) represents an m-th element in a j-th slot of d(w^{t});

s(w_{j,m}^{t}) represents an m-th element in a j-th slot of s(w^{t});

uⱼ represents a vector associated with a j-th slot in the second parameter vector; and

vⱼ represents an eigen vector of a j-th slot.

In an implementation, the vⱼ is determined by:

representing each element associated with a j-th slot in the st parameter vector by a three-dimensional vector (w_{j,m}^{t}, d(w_{j,m}^{t}), s(w_{j,m}^{t}), wherein m is an index of the element in the j-th slot;

performing a clustering on the three-dimensional vector of the element associated with the j-th slot via a K-means algorithm, to obtain 1 central points for the j-th slot, wherein the 1 is an integer;

calculating reciprocals of the distances between the three-dimensional vector of the element associated with the j-th slot and the 1 central points for the j-th slot respectively, and setting the reciprocals as elements of the vⱼ; and

forming the vⱼ by the elements.

In an implementation, the vⱼ is determined by:

representing a j-th slot of the first parameter vector by a set of three-dimensional vectors (wⱼ^{t}, d(wⱼ^{t}), s(wⱼ^{t}), wherein the wⱼ^{t} is a vector associated with a j-th slot of the w^{t}, the d(wⱼ^{t}) is a vector associated with a j-th slot of the d(w^{t}), and the s(wⱼ^{t}) is a vector associated with a j-th slot of the s(w^{t}); and

re-representing the set of three-dimensional vectors through a Gauss mixture model, and estimating the vⱼ in a maximum expectation algorithm.

In an implementation, the apparatus further includes

a training set and validation set determination module, configured to divide dynamically streaming data with a sliding window, to obtain the training set and the verification set.

In a third aspect, a device for optimizing an Ad CTR estimation model is provided according to an embodiment of the present application. The functions of the device may be implemented by using hardware or by corresponding software executed by hardware. The hardware or software includes one or more modules corresponding to the functions described above.

In a possible embodiment, the device structurally includes a processor and a memory, wherein the memory is configured to store a program which supports the device in executing the above method for optimizing an Ad CTR estimation model. The processor is configured to execute the program stored in the memory. The device may further include a communication interface through which the device communicates with another devices or communication networks.

In a fourth aspect, a computer-readable storage medium for storing computer software instructions used for a device for optimizing an Ad CTR estimation model is provided. The computer readable storage medium may include programs involved in executing of the method for optimizing an Ad CTR estimation model described above.

One of the above technical solutions has the following advantages or beneficial effects: in the method and apparatus for optimizing an Ad CTR estimation model according to embodiments of the present application, an update function used for optimizing parameters of an Ad CTR estimation model (in embodiments of the present application, the update function is represented by w^{t+1}=F(w^{t}, d(w^{t}), s(w^{t}))) is re-defined, an optimization of an original first parameter vector (in embodiments of the represent application, the first parameter vector is represented by w) is transformed into an optimization of a updated second parameter (in embodiments of the present application, the second parameter vector is represented by u). It can be seen that in embodiments of the present application, a manual setting of the hyper parameter θ when performing a Grid Search is avoided, so that better optimization results may be obtained.

The above summary is provided only for illustration and is not intended to be limiting in any way, In addition to the illustrative aspects, embodiments, and features described above, further aspects, embodiments, and features of the present application will be readily understood from the following detailed description with reference to the accompanying drawings.

### BRIEF DESCRIPTION OF THE DRAWINGS

In the drawings, unless otherwise specified, identical or similar parts or elements are denoted by identical reference numerals throughout the drawings. The drawings are not necessarily drawn to scale. It should be understood that these drawings merely illustrate some embodiments of the present application and should not to be construed as limiting the scope of the present application.

FIG. 1 is a schematic diagram showing a numerical curve of a Sigmoid function according to an embodiment of the present application;

FIG. 2 is a schematic diagram showing a mapping of a high dimensional feature week, gender, city) according to an embodiment of the present application;

FIG. 3 is a flowchart showing an implementation of a method for optimizing an Ad CTR estimation model according to an embodiment of the present application;

FIG. 4 is a schematic diagram showing a comparison of a parameter optimization path according to an embodiment of the present application with a parameter optimization path in the existing technology;

FIG. 5 is a schematic diagram showing slot characteristics in a method for optimizing an Ad CTR estimation model according to an embodiment of present application;

FIG. 6 is a schematic diagram showing a dynamic dividing of a training set and a verification set in a method for optimizing an Ad CTR estimation model according to an embodiment of present application;

FIG. 7 is a schematic structural diagram I of an apparatus for optimizing an Ad CTR estimation model according to an embodiment of present application;

FIG. 8 is a schematic structural diagram II of an apparatus for optimizing an Ad CTR estimation model according to an embodiment of present application; and

FIG. 9 is a schematic structural diagram of a device for optimizing an Ad CTR estimation model according to an embodiment of present application.

### DETAILED DESCRIPTION OF THE EMBODIMENTS

In the following, only certain exemplary embodiments are briefly described. As can be appreciated by those skilled in the art, the described embodiments may be modified in different ways, without departing from the spirit or scope of the present application. Accordingly, the drawings and the description should be regarded as illustrative in nature instead of being restrictive.

By using the Ad CTR estimation model established based on machine learning theory, rules may be automatically discovered from a limited (small) number of advertisement display/click logs, so as to determine parameters of the model. Moreover, after log data is trained (optimized), the optimized parameters may be directly used for more accurate estimation/inference of the Ad CTR of other large amount of advertisements, especially of those candidate advertisements that are not sufficiently presented and that do not have enough click history.

Currently, an Ad CTR estimation model is the Logistic Regression (LR) model, The LR model is usually used in conjunction with an eigenvector x with ultra-high dimension (which may reach trillion levels). As shown in Formula (1), the CTR is specifically defined as a Sigmoid function δ (z), it should be noted that in the present application, bold lowercase letters represent vectors, non-bold lowercase letters represent scalars, and bold uppercase letters represent matrices.

$$δ ( z ) = \frac{1}{1 + {e}^{- z}} \qquad ( 1 )$$

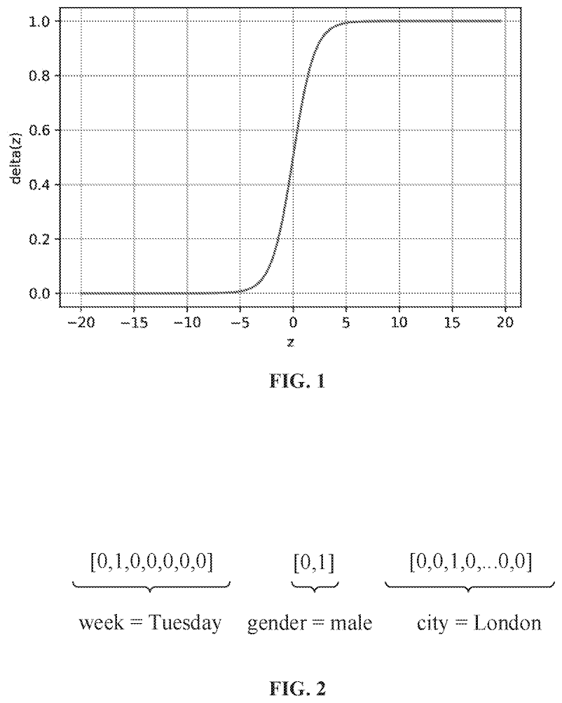

In above Formula (1), a range of the value of CTR is (0, 1). FIG. 1 is a schematic diagram of a numerical curve of a Sigmoid function in the existing technology.

e^{-z} is a natural power exponent with −z as the parameter, and Z is defined as an inner product of a large-scale eigenvector x and a corresponding weight vector w with the same dimension (alternatively, it may be understood as a weighted summation of features)

Z is determined by Formula (2):

z=w·x (2)

In a scenario of searching for an advertisement, a large-scale eigenvector x for estimating an Ad CTR generally includes various characteristics of a user, textual features of a users search word, various text, image and video features of a candidate advertisement, and the like. The characteristics of the user may include gender, region, age, preference of the user.

Taking simple textual features as an example. In the case of using a one-hot encoding method, each word is individually regarded as a feature with one dimension. Since the number of Chinese words is very large (hundreds of thousands), the number of textual features of Chinese words alone may reach hundreds of thousands, or even millions. This also explains why the overall dimension of the eigenvector x may reach nearly trillion.

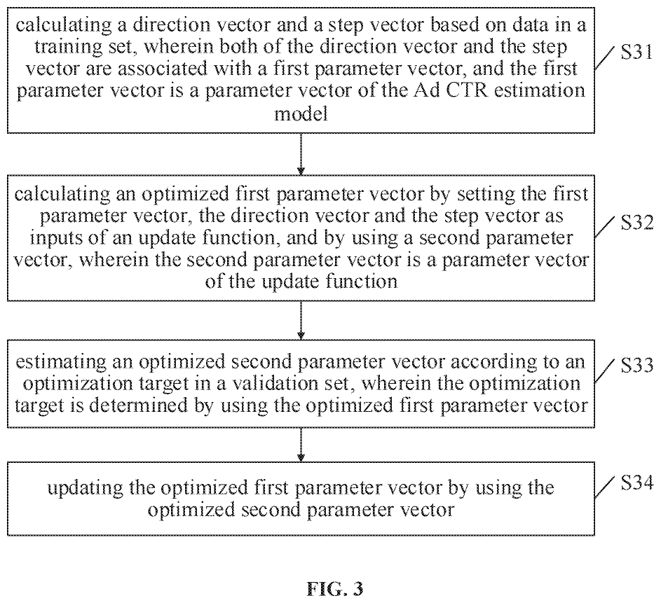

If each data (consisting of a specific advertisement, a specific user, a specific advertiser, and a specific search word) is mapped to discrete features with nearly trillion dimensions by using the one-hot encoding method, a very sparse binary vector will be obtained. That is, only a few features are assigned a value of 1, and many other eigenvalues are 0. FIG. 2 is a schematic diagram showing a mapping of high dimensional features (week, gender, city). The “week” slot has seven dimensions (Monday to Sunday), the gender slot has two dimensions (male and female), and the city slot has much higher dimensions (all cities that need to be considered). For specific data (week=2, gender=male, city=London), only three of the dimensions may be selected and assigned a value of 1, the remaining large proportion of the eigenvalues are all 0. This kind of performance is called as sparse. Here, broader high-level categories (week, gender, city) of each feature are often collectively referred to as “slot”.

For scenarios without search words, it is required that the vector x still includes other various high dimensional discrete features of a user, an advertisement and an advertiser, instead of search words.

With the rise and development of deep learning in recent years, many discrete sparse textual features may be transformed into representations of low-dimensional dense vectors by applying methods, such as the word vector method. Embodiments of present application are applicable to both high dimensional discrete eigenvectors and low dimensional dense eigenvectors.

For an advertisement with a k-dimension eigenvector x ∈ [symbol] ^{k}( [symbol] stands for positive range), y represents whether the advertisement is actually clicked (y=1 represents clicked; y=0 represents not clicked). According to a joint definition of Formula (1) and Formula (2), the probability of an advertisement being clicked is:

$$P ( y = 1 \vert x \text{;} w ) = {h}_{w} ( x ) = \frac{1}{1 + {e}^{- w \cdot x}} \qquad ( 3 )$$

The probability of an advertisement not being clicked is:

P(y=0|x;w)=1−h_{w}(x) (4)

Through integrating Formulas (3) and (4), the probability of a CTR estimation may he defined as:

P(y|x; w)=(h_{w}(x))^{y}(1−h_{w}(x))^{1-y} (5)

According to the probability hypothesis of Formula (5), it is assumed that a training set is Δₜᵣₐᵢₙ={(x⁽ⁱ⁾, y⁽ⁱ⁾); i=1, . . . m}, where data, whether m advertisements are clicked, are included. It is desirable to maximize the joint probability of m data, in order to take the maximization result as an optimization target of a CTR estimation model, and to further obtain an optimal parameter w in the case of achieving the target. As shown in Formula 6:

$$arg {max}_{w} {\prod }_{( {x}^{( i )} , {y}^{( i )} ) ∈ {Δ}_{train}} P ( {y}^{( i )} \vert {x}^{( i )} \text{;} w ) \qquad ( 6 )$$

After performing a natural logarithm operation on Formula (6) and then performing a negation operation, a final optimization target of a basic LR model, which is used as the CTR estimation model, is obtained. The final optimization target is then to minimize Lₜᵣₐᵢₙ(w), where Lₜᵣₐᵢₙ(w)=−Σ₍ₓ_{⁽ⁱ⁾}_{,y}_{⁽ⁱ⁾}_{)∈Δ}_{ₜᵣₐᵢₙ}y⁽ⁱ⁾log h_{w}(x⁽ⁱ⁾)+(1−y⁽ⁱ⁾)log(1−h_{w}(x⁽ⁱ⁾)).

Thus, the final optimization target is as shown in Formula (7):

$${argmin}_{w} {L}_{train} ( w ) = {argmin}_{w} - {\sum }_{( {x}^{( i )} , {y}^{( i )} ) ∈ {Δ}_{train}} {y}^{( i )} log {h}_{w} ( {x}^{( i )} ) + ( 1 - {y}^{( i )} ) log ( 1 - {h}_{w} ( {x}^{( i )} ) ) \qquad ( 7 )$$

However, in a large-scale Ad CTR estimation model applied to actual companies, the number of dimensions k of an eigenvector in the above optimization target may usually reach several trillions, while the amount of data m that can be collected every day is generally only several hundreds of millions. That is, the amount of data m used for training is much smaller than the number of parameters (weights) k. In other words, the freedom degree of a model is too high, thus, for an optimized model, an overfitting is prone to occur.

in order to avoid the occurrence of overfitting, in the existing technology, the following two improvements are made.

1) Considering that large-scale features are quite sparse per se, if in an optimization process, an optimization target that parameters (weights) of a model are gradually made sparse may be achieved, that is, a large number of parameters may be turned into 0, the number of parameters may be indirectly reduced, so that the freedom degree of the model and the possibility of overfitting may be reduced. In order to achieve the optimization target that parameters (weights) are made more sparse, in the existing technology, by adding a constraint of L1-Norm (i.e., the 1-norm of the parameter: ∥w∥₁) based on the basic optimization target (Formula (7)), a new optimization target Jₜᵣₐᵢₙ(w, θ), is obtained as follows:

Jₜᵣₐᵢₙ(w, θ)=Lₜᵣₐᵢₙ(w)+θ×∥w∥₁ (8).

In Formula (8), ∥w∥₁=Σᵢ₌₁^{k}|wᵢ|, which is absolute values of a k-dimensional parameter vector are evaluated item by item, and then a sum is obtained. Intuitively speaking, in the case where a Norm term is introduced as a constraint, the value of ∥w∥₁ may be relatively small only when most of the parameters in w could be zero. Since the overall optimization target is to minimize Jₜᵣₐᵢₙ(w, θ), many parameters in w may be turned into 0 in this way. Moreover, the hyper parameter θ needs to be set manually to adjust the proportion of the Norm (the 1-norm of the parameter: ∥w∥₁) to the overall optimization target.

2) In addition to a training set, a validation set is constructed, to more objectively evaluate the quality of a model optimization. It must be ensured that the data in the validation set does not appear in the training set, that is, Δₜᵣₐᵢₙ ∩ Δ_{valid}=Ø, wherein Δₜᵣₐᵢₙ is the training set, Δ_{valid} is the validation set.

Based on the above two points, the existing algorithmic process for optimizing LR model parameters with Norm terms is as follows:

1. preparing two data sets: a training set Δₜᵣₐᵢₙ and a validation set Δ_{valid};

2. manually setting a search range [a, b] of θ and performing a Grid search with a step of c, and constructing a candidate hyper parameter list Θ=[a, a+c, a+2c, . . . , b] under the assumption that there are M candidate hyper parameters from a to b (including: a, a+c, a+2c, . . . , b);

3. defining an empty list L;

4. performing a random initialization on the parameter w;

5. for each hyper parameter θ(Θ=Θ[i], where i=1˜M) in Θ, performing the following steps separately:
with a target of minimizing Jₜᵣₐᵢₙ(w, θ) based on the training set Δₜᵣₐᵢₙ performing an internal optimization on the parameter w through T rounds of learning by adopting a manually defined optimization strategy, where j indicates an index of the number of optimizations, j=1˜T;
substituting a currently learned parameter w into L_{valid}(w), to obtain a model loss L_{valid} based on the validation set L_{valid}(w) in the round, and adding the model loss into the list L;

6. selecting an index j corresponding to the minimum loss based on the validation set from the list L; and

7. taking the optimization parameter w and the hyper parameter θ of the j-th round as the parameters of the final model.

It can be seen from the above algorithm that in addition to the introduction of a “1-norm” term (the L1-norm), a limitation that the hyper parameter 0 is required to be manually set is added. Even in the case of performing a Grid. Search, it is still necessary to manually set the search range and the search step. In other words, an obtained hyper parameter θ is only a relatively optimal result within the search range, rather than a global optimal result. Moreover, manually finding corresponding hyper parameters increases the complexity of model screening. According to the introduction of the above algorithm, T*M rounds of optimization are basically required to be performed. In addition, the schemes and rules adopted in existing optimization techniques are static for different training data and application scenarios.

A method and apparatus for optimizing an Ad CTR estimation model are provided, according to embodiments of the present application. Specifically, embodiments of the present application refer to a parameter autonomous learning method for optimizing an Ad CTR. estimation model. The applicable scope of this method is: using the Logistic Regression (LR) as a platform basis for the Ad CTR estimation model. The parameter autonomous optimization method provided and disclosed in embodiments of present application may be used to train an Ad CTR estimation model with the LR as a platform basis.

The technology disclosed in embodiments of the present application belongs to an emerging field of Meta-learning. Different from the update/optimization anode in the existing technology in which parameters of an Ad CTR estimation model need to be manually defined, in embodiments of the present application, an autonomous learning method is introduced in the mechanism for updating/optimizing parameters of an Ad CTR estimation model, so that the parameter optimization mode is constructed as a system that may adaptively adjust itself to learn, that is an optimizer as learner.

Hereafter, developments of technical solutions are described in detail according to following embodiments.

FIG. 3 is a flowchart showing an implementation of a method for optimizing an Ad CTR estimation model according to an embodiment of the present application. The method includes calculating a direction vector and a step vector based on data in a training set, wherein both of the direction vector and the step vector are associated with a first parameter vector, and the first parameter vector is a parameter vector of the Ad CTR estimation model at S31 calculating an optimized first parameter vector by setting the first parameter vector, the direction vector and the step vector as inputs of an update function, and by using a second parameter vector, wherein the second parameter vector is a parameter vector of the update function at S32; estimating an optimized second parameter vector according to an optimization target in a validation set, wherein the optimization target is determined by using the optimized first parameter vector at S33; and updating the optimized first parameter vector by using the optimized second parameter vector at S34.

The above process describes a round of iteration. In embodiments of the present application, parameters of a CTR estimation model may be optimized by T round iterations.

In the t-th round iteration,

the update function is represented as w^{t-1}=F(w^{t}, d(w^{t}), s(w^{t}));

the first parameter vector is represented as w^{t};

the direction vector associated with w^{t} is represented as d(w^{t});

the step vector associated with w^{t} is represented as s(w^{t});

the optimized first parameter vector is represented as w^{t+1};

the second parameter vector is represented as u^{t}; and

the optimized second parameter vector is represented as u^{t+1}.

In an implementation, the calculating a direction vector and a step vector based on data in a training set at S31 includes:

calculating elements of the direction vector with a following formula, and forming the direction vector by the calculated elements;

$$d ( {w}_{i}^{t} ) = log \frac{α + click ( {x}_{i} )}{α + predict ( {x}_{i} )} ,$$

wherein

d(wᵢ^{t}) represents an i-th element in the direction vector in a t-th round optimization;

αis a positive number larger than 0 and less than 1;

xᵢ represents an i-th feature of a feature vector of the Ad CTR estimation model;

click(xᵢ) represents an actual click number of the xᵢ in the training set; and

predict(xᵢ) represents an estimated click number of the xᵢ.

In an implementation, the calculating a direction vector and a step vector based on data in a training set at S31 includes:

calculating elements of the step vector with a following formula, and forming the step vector by the calculated elements;

s(wᵢ^{t})=log(β+impression(xᵢ)), wherein

s(wᵢ^{t}) represents an i-th element of the step vector in a t-th round optimization;

β is a positive number larger than 0 and less than, 1,

xᵢ represents an i-th feature of a feature vector of the Ad CTR estimation model; and

impression(xᵢ) represents a number of times that the xᵢ is presented in the training set.

In an implementation, the update function is defined by a following formula:

w^{t+1}=F(w^{t}, d(wₜ), s(w^{t})), wherein

w^{t+1} represents the first parameter vector in the t-th round optimization;

w^{t} represents the first parameter vector in the t-th round optimization;

d(w^{t}) represents the direction vector with the w^{t} in the t-th round optimization; and

s(w^{t}) represents the step vector associated with the w^{t} in the t-th round optimization.

In an implementation, the w^{t+1} is determined by:

calculating elements of the w^{t+1} with a following formula, and forming w^{t+1} by the calculated elements;

w_{j,m}^{t+1}+F(w_{j,m}^{t}d(w_{j,m}^{t}), s(w_{j,m}^{t}))=w_{j,m}^{t}+uⱼ·vⱼ, wherein

w_{j,m}^{t+1} represents an m-th element in a j-th slot of w^{t+1};

w_{j,m}^{t} represents an m-th element in a j-th slot of w^{t};

d(w_{j,m}^{t}) represents an m-th element in a j-th slot of d(w^{t}).

s(w_{j,m}^{t}) represents an m-th element in a j-th slot of s(w^{t});

uⱼ represents a vector associated with a j-th slot in the second parameter vector; and

vⱼ represents an eigenvector of a j-th slot.

In an embodiment, the vⱼ is determined by:

representing each element associated with the a j-th slot in the first parameter vector by a three-dimensional vector (w_{j,m}^{t}, d(w_{j,m}^{t}), s(w_{j,m}^{t})), wherein m is an index of the element in the j-th slot;

performing a clustering on the three-dimensional vector of the element associated with the j-th slot via a K-means algorithm, to obtain 1 central points for the j-th slot, wherein the I is an integer;

calculating reciprocals of the distances between the three-dimensional vector of the element associated with the j-th slot and the 1 central points for the j-th slot respectively, and setting the reciprocals as elements of the vⱼ; and

forming the vⱼ by the elements.

In an implementation, the vⱼ is determined by:

representing a j-th slot of the first parameter vector by a set of three-dimensional vectors (wⱼ^{t}, d(wⱼ^{t}, s(wⱼ^{t})), wherein the wⱼ^{t} is a vector associated with a j-th slot of the w^{t}, the d(wⱼ^{t}) is a vector associated with a j-th slot of the d(w^{t}), and the s(wⱼ^{t}) is a vector associated with the j-th slot of the s(w^{t}); and

re-representing the set of three-dimensional vectors through a Gauss mixture model, and estimating the vⱼ in a maximum expectation algorithm.

In an embodiment, the training set and the validation set are determined by:

dividing dynamically streaming data with a sliding window, to obtain the training set and the verification set.

In the following, specific embodiments are described in detail.

According to embodiments of the present application, a general rule related to an optimization through parameter iterations may be derived, that is, an optimization value of a parameter w^{t+1} in a (t+1)-th round is related to three factors, specifically a parameter vector w^{t} in the previous iteration, a direction d(w^{t}) in which an action is to be started in the (t+1)-th round, and a step s(w^{t}) with which a forward/back moving in the action direction is prepared, wherein both d(w^{t}) and s(w^{t}) are functions of w^{t}. As a result, the optimization value of the parameter w^{t+1} in the (t+1)-th round may be defined by using a general function F, which is w^{t+1}=F(w^{t}, d(w^{t}), s(w^{t})).

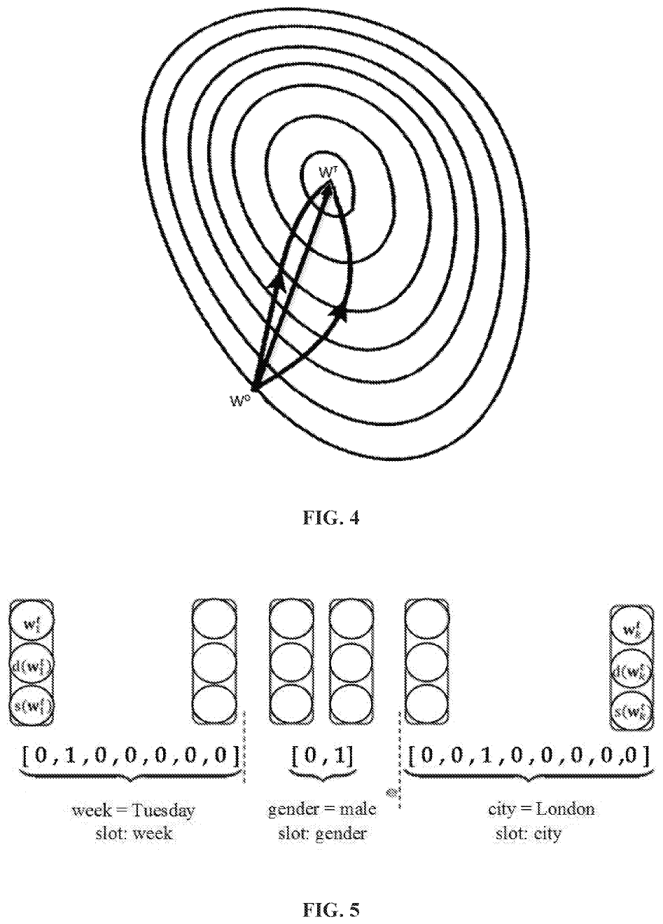

Comparing with the existing technology, a broader parameter optimization scheme is disclosed in embodiments of the present application, whereby the manually defined parameter optimization mode is improved and modeled at a higher level. FIG. 4 is a schematic diagram showing a comparison of a parameter optimization path according to an embodiment of the present application and a parameter optimization path in the existing technology. In FIG. 4, the two curves with arrows represent parameter optimization paths obtained by using the existing stochastic gradient descent (SGD) method and the quasi Newton method (such as LBFGS, OWLQN). A line segment with an arrow in the middle represents a parameter optimization path according to an embodiment of present application. According to embodiments of present application, learning to optimize (Optimizer as a Learner, which is OASL) based on different data environments and application scenarios may be implemented, so as to obtain an optimal path.

The parameter autonomous learning method (i.e., OAR.) for optimizing an Ad CTR estimation model provided by embodiments of the present application includes:

1. assuming that T round iterations need to be performed to optimize parameters of a CTR estimation model;

2. performing a random initialization on the parameter w of a LR model;

3. performing a random initialization on the parameter u of a general function F;

4. preparing two data sets: a training set Δₜᵣₐᵢₙ and a validation set Δ_{valid};

5. performing T round optimizations, wherein the steps in the t-th (t=1T) round optimization includes:

calculating d(w^{t}) and s(w^{t}) based on data in the training set Δₜᵣₐᵢₙ;

calculating , w^{t+1}=F(w^{t}, d(w^{t}), s(w^{t})) by using the current parameter u^{t}:

estimating u^{t+1} according to an optimization target argminᵤL_{valid}(w^{t+1}) in the validation set Δ_{valid}; and

updating the parameter w^{t+1}=F(w^{t},d(w^{t}), s(w^{t})) by using the latest estimated u^{t+1}.

In the above, the optimization target argminᵤL_{valid}(w^{t+1}) refers to:

finding a value of u, which could minimize the value of L_{valid}(w^{t+1}), wherein L_{valid}(w^{t+1})=−Σₓ_{⁽ⁱ⁾}_{, y}_{⁽ⁱ⁾}_{└Δ}_{_{valid}}y⁽ⁱ⁾log h_{w}_{^{t+1}}(x⁽ⁱ⁾)+(1−y⁽ⁱ⁾log(1−h_{w}_{^{t+1}}(x⁽ⁱ⁾)).

The specific design and calculation methods of d(w^{t}) and s(w^{t}) and F(w^{t}, d(w^{t}), s(w^{t})) in an CTR estimation model are described in detail below

First of all, it should be emphasized that both inputs d(w^{t}) and s(w^{t}) are vectors of w^{t} with ultra-high k dimensions. In order to facilitate parallel optimization of parameters of industrial products (which is also an advantage of the OASL algorithm provided in accordance with embodiments of the present application in engineering implementation), in embodiments of the present application, the direction vector d(w^{t}) and the step vector s(w^{t}) on each dimension of a specific parameter wᵢ^{t}(i=1, . . . k) may be calculated in a statistical manner.

d(wᵢ^{t}) is the i-th element of the direction vector d(wₜ). d(wᵢ^{t}) depends on a logarithmic difference between a number of times the feature xᵢ at a position corresponding to an index i is actually clicked and a number of times the feature xᵢ is estimated to be clicked in a training set. d(wᵢ^{t}) may be calculated with Formula (9):

$$d ( {w}_{i}^{t} ) = log \frac{α + click ( {x}_{i} )}{α + predict ( {x}_{i} )} \qquad ( 9 )$$

In above Formula (9), a. is a small positive number in the range of (1.0), which is used for smoothing

$$\frac{click ( {x}_{i} )}{predict ( {x}_{i} )} ,$$

so as to ensure both the denominator α+predict(xᵢ) and itself

$$\frac{α + click ( {x}_{i} )}{α + predict ( {x}_{i} )}$$

are not (0.

s(wᵢ^{t}) is the i-th element of the step vector s(w^{t}), which may be understood as a confidence of a forward (backward) moving. s(wᵢ^{t}) depends on a number of times the feature xᵢ at a position corresponding to an index i is presented in a training set. The greater the number of times that the xᵢ is presented, the higher the confidence is. s(wᵢ^{t}) may be calculated with Formula (10):

s(wᵢ^{t})=log(β+impression(xᵢ) (10)

In above Formula (9), β is also a small positive number in the range of (1.0), which is used for ensuring β+impression(xᵢ) is not 0.

For the update function F, the inputs of which are three k-dimensional vectors in the t-th round iteration, namely w^{t}, d(w^{t}) and s(w^{t}), and an expected output is a k-dimensional update parameter w^{t+1} in the (t+1)-th round.

FIG. 5 is a schematic diagram showing slot characteristics in a method for optimizing an Ad CTR estimation model according to an embodiment of present application. In FIG. 5, the feature with i-th dimension is corresponding to a three-dimensional vector (wᵢ^{t}, d(wᵢ^{t}), s(wᵢ^{t})). Thus, in embodiments of the present application, an ultra-high dimensional eigenvector x may be converted into a combination of n slot eigenvectors, which is x=[s₁, s₂, . . . , sₙ].

In order to reduce the size of parameters that need to be optimized, according to embodiments of the present application, a clustering may be performed on all the three-dimensional vectors in each slot via a K-means algorithm, and l center points for each slot may be obtained, where 1 is much smaller than k (1«k). Taking the slot Sⱼ as an example, assuming that a low-dimensional eigenvector corresponding to the slot re-represented by the l central points is oⱼ=[c_{j,1}, . . . , c_{j,l}]. The three-dimensional vector (w_{j,m}^{t}, d(w_{j,m}^{t}), s(w_{j,m}^{t})) corresponding to the m-th element in the slot Sᵢ may all be re-represented by oⱼ, and reciprocals of the distances (the farther the distance, the smaller the weight between (w_{j,m}^{t}, d(w_{j,m}^{t}), s(w_{j,m}^{t})) and all the central points of o^{j} may) be set as elements of the new eigenvector vⱼ ∈ [symbol] ^{l} in the slot Sⱼ.

In addition to the K-means algorithm, according to an embodiment of the present application, a clustering may be performed on all the three-dimensional vectors in each slot directly by using the Gaussian Mixture Model (GMM), to obtain l central points for each slot, where l is much smaller than k (l«k). In this way, taking the slot Sⱼ as an example, the set of three-dimensional vector (wⱼ^{t}, d(wⱼ^{t}), s(w^{t})) corresponding to the slot may be re-represented via the GMM, and vⱼ=(v_{j,1}, . . . v_{j,l}) may be estimated by using the maximum expectation algorithm (EM). It may be determined with Formula (11):

wⱼ^{t}, d(wⱼ^{t}), s(wⱼ^{t})=Σₖ₊₁^{l}v_{j,k}N(c_{j,k}, Q_{j,k}) (11)

In Formula (11), N(c_{j,k}, Q_{j,k}) is a normal distribution with c_{j,k} as a mean and Q_{j,k} as a covariance matrix. v_{j,k} is the ratio (weight) of wⱼ^{t}, d(wⱼ^{t}), s(wⱼ^{t}) in the k-th normal distribution.

Thus, in the process of calculating each original high dimensional weight vector w_{j,m}^{t+1}, according to embodiments of the present application, it is only necessary to update and optimize a new weight vector uⱼ with a lower dimension, which is represented with the following Formula (12):

w_{j,m}^{t+1}=F(w_{j,m}^{t}, d(w_{j,m}^{t}), s(w_{j,m}^{t}))=w_{j,m}^{t}+uⱼ·vⱼ (12)

Thus, according to embodiments of the present application, it is only necessary to optimize the new weight vector uⱼ ∈ [symbol] ^{l} with a lower dimension in an optimization process in a validation set, where uⱼ is a vector corresponding to the j-th slot in U. In practical applications, original high dimensional discrete features generally have several trillions of dimensions, involving about 500 feature slots. For each feature slot, 100 central points are generally obtained by a clustering in accordance with embodiments of the present application. Therefore, the dimension of u is only about 500*100=50000, which is much smaller than several trillions.

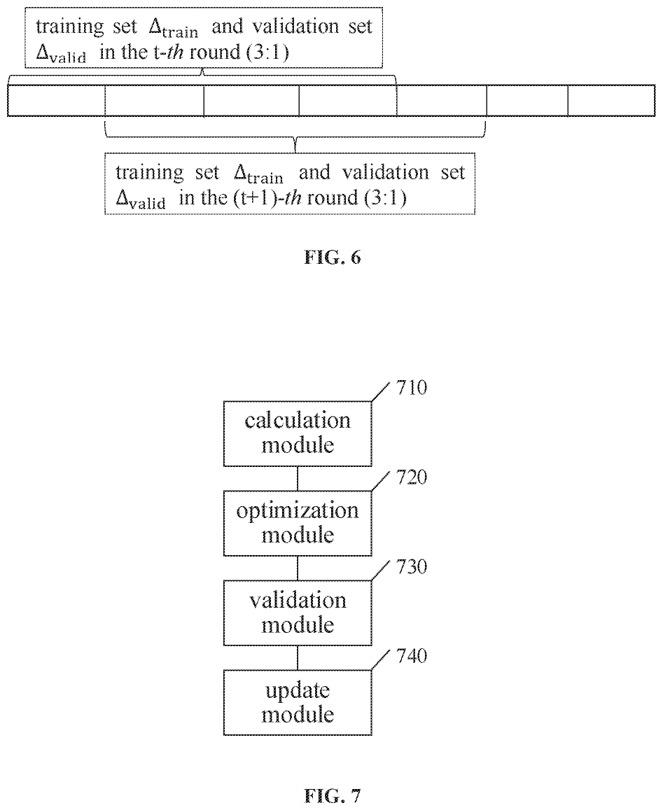

In a possible implementation, a training set and a verification set may be obtained by dividing dynamically streaming data with a sliding window in the process of training an Ad CTR estimation model provided by embodiments of the present application. FIG. 6 is a schematic diagram showing a dynamic dividing of a training set and a verification set in a method for optimizing an Ad CTR estimation model according to an embodiment of present application. In FIG. 6, a sliding window is used to divide, so as to obtain the training set and the verification set, wherein each of the grids may represent the click data of the advertisements collected every day (the dividing granularity may be customized).

In summary, the method for optimizing an Ad CTR estimation model provided by embodiments of the present application has at least the following advantages:

1) a manual (grid) setting/search for a norm term hyper parameter in the case of a traditional LR model with a norm term is avoided;

2) the “optimizer as learner” method in embodiments of the present application may autonomously adapt to field data in different scenarios, so as to achieve an effect of “with different set of data, learning a different set of optimization method”, in this way, model parameters may be individually optimized, thereby significantly reducing adverse effects of a model overfitting, and thus an estimation of an Ad CTR may be more accurate;

3) since the “optimizer as learner” method in embodiments of the present application may autonomously learn the best Ad CTR model optimization mode, the convergence speed of a process for optimizing an Ad CTR model is also significantly accelerated.

An apparatus for optimizing an Ad CTR estimation model is provided in an embodiment of the present application. FIG. 7 is a schematic structural diagram of an optimization apparatus for Ad CTR prediction model according to an embodiment of present invention. As illustrated in FIG. 7, the apparatus includes:

a calculation module 710, configured to calculate a direction vector and a step vector based on data in a training set, wherein both of the direction vector and the step vector are associated with a first parameter vector, and the first parameter vector is a parameter vector of the Ad CTR estimation model;

an optimization module 720, configured to calculate an optimized first parametervector by setting the first parameter vector, the direction vector and the step vector as inputs of an update function, and by using a second parameter vector, wherein the second parameter vector is a parameter vector of the update function;

a validation module 730, configured to estimate an optimized second parameter vector according to an optimization target in a validation set, wherein the optimization target is determined by using the optimized first parameter vector; and

an update module 740, configured to update the optimized first parameter vector by using the optimized second parameter vector.

In a possible implementation, the calculation module 710 is configured to:

calculate elements of the direction vector with a following formula, and form the direction vector by the calculated elements;

$$d ( {w}_{i}^{t} ) = log \frac{α + click ( {x}_{i} )}{α + predict ( {x}_{i} )} ,$$

wherein

d(wᵢ^{t}) represents an i-th element of the direction vector in a t-th round optimization;

α is a positive number larger than 0 and less than 1;

xᵢ represents an i-th feature of a feature vector of the Ad CTR estimation model;

click(xᵢ) represents an actual click number of the xᵢ, in the training set; and

predict(xᵢ) represents an estimated click number of the xᵢ.

In a possible implementation, the calculation module 710 is configured to:

calculate elements of the step vector with a following formula, and form the step vector by the calculated elements;

s(wᵢ^{t})=log(β+impression(xᵢ)), wherein

s(wᵢ^{t}) represents an i-th element of the step vector in a t-th round optimization;

β is a positive number larger than 0 and less than 1;

xᵢ represents an i-th feature of a feature vector of the Ad CTR estimation model; and

impression(xᵢ) represents a number of times that the xᵢ, is presented in the training set.

In a possible implementation, the update function is defined by a following formula:

w^{t+1}=F(w^{t}, d(w^{t}), s(w^{t})), wherein

w^{t+1} represents the optimized first parameter vector in a t-th round optimization;

w^{t} represents the first parameter vector in the t-th round optimization;

d(w^{t}) represents the direction vector associated with the w^{t} in the t-th round optimization; and

s(w^{t}) represents the step vector associated with the w^{t} in the t-th round optimization.

In a possible implementation, the optimization module 720 is configured to calculate elements of the w^{t+1} with a following formula, and forming the w^{t+1} by the calculated elements;

w_{j,m}^{t+1}=F(w_{j,m}^{t}, d(w_{j,m}^{t}), s(w_{j,m}^{t}))=w_{j,m}^{t}+uⱼ·vⱼ, wherein

w_{j,m}^{t+1}represents an m-th element in a j-th slot of w^{t+1};

w_{j,m}^{t} represents an m-th element in a j-th slot of w^{t};

d(w_{j,m}^{t}) represents an m-th element in a j-th slot of d(w^{t});

s(w_{j,m}^{t}) represents an m-th element in a j-th slot of s(w^{t});

uⱼ represents a vector associated with a j-th slot in the second parameter vector; and

vⱼ represents an eigenvector of a j-th slot of a j-th slot.

In a possible implementation, the vⱼ is determined by:

representing each element associated with a j-th slot in the first parameter vector by a three-dimensional vector (w_{j,m}^{t}, d(w_{j,m}^{t}), s(w_{j,m}^{t})), wherein m is an index of the element in the j-th slot;

performing a clustering on the three-dimensional vector of the element associated with the j-th slot via a K-means algorithm, to obtain 1 central points for the j-th slot, wherein the 1 is an integer;

calculating reciprocals of the distances between the three-dimensional vector of the element associated with the j-th slot and the 1 central points for the j-th slot respectively, and setting the reciprocals as elements of the vⱼ; and

forming the vⱼ by the elements.

In a possible implementation, the vⱼ is determined by:

representing a j-th slot of the first parameter vector by a set of three-dimensional vectors (wⱼ^{t}, d(wⱼ^{t}), s(wⱼ^{t})), s(wⱼ^{t})), wherein the wⱼ^{t} is a vector associated with a j-th slot of the w^{t}; the d(wⱼ^{t}) is a vector associated with a j-th slot of the d(w^{t}), and the s(wⱼ^{t}) is a vector associated with a j-th slot of the s(w^{t}); and

re-representing the set of three-dimensional vectors through a Gauss mixture model, and estimating the v₁ in a maximum expectation algorithm.

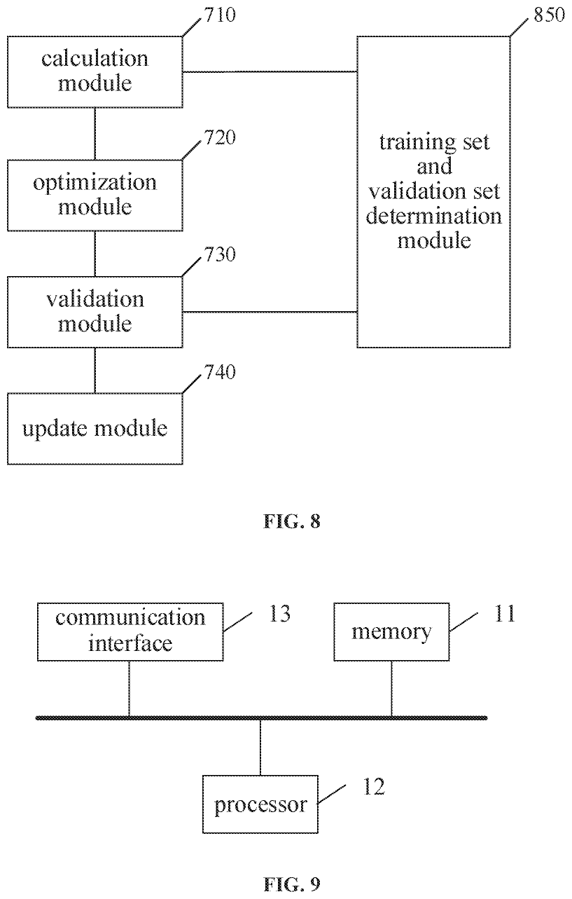

FIG. 8 is a schematic structural diagram II of an apparatus for optimizing an Ad CTR estimation model according to an embodiment of present application. The apparatus includes a calculation module 710, an optimization module 720, a validation module 730, an update module 740 and a training set and validation set determination module 850. The calculation module 710, the optimization module 720, the validation module 730, and the update module 740 are the same as the corresponding models in above embodiments, thus a detailed description thereof is omitted herein.

The training set and validation set determination module 850 is configured to divide dynamically streaming data with a sliding window, to obtain the training set and the verification set.

In this embodiment, functions of modules in the apparatus refer to the corresponding description of the method mentioned above and thus a detailed description thereof is omitted herein.

A device for optimizing an Ad CTR estimation model is further provided according to an embodiment of the present application. FIG. 9 is a schematic structural diagram showing a device for optimizing an Ad CTR estimation model according to an embodiment of the present application. The device includes a memory 11 and a processor 12, wherein a computer program that can run on the processor 12 is stored in the memory 11. The processor 12 executes the computer program to implement the method for optimizing an Ad CTR estimation model according to the foregoing embodiments. The number of either the memory 11 or the processor 12 may be one or more.

The apparatus further includes a communication interface 13 configured to communicate with external devices and exchange data.

The device may further include a communication interface 13 configured to communicate with an external device and exchange data.

The memory 11 may include a high-speed RAM memory and may also include a non-volatile memory, such as at least one magnetic disk memory.

If the memory 11, the processor 12, and the communication interface 13 are implemented independently, the memory 11, the processor 12, and the communication interface 13 may be connected to each other via a bus to realize mutual communication. The bus may be an Industry Standard Architecture OSA) bus, a Peripheral Component Interconnected (PCI) bus, an Extended

Industry Standard Architecture (EISA) bus, or the like. The bus may be categorized into an address bus, a data bus, a control bus. and the like. For ease of illustration, only one bold line is shown in FIG. 4 to represent the bus, but it does not mean that there is only one bus or one type of bus.

Optionally, in a specific implementation, if the memory 11, the processor 12, and the communication interface 13 are integrated on one chip, the memory 11, the processor 12, and the communication interface 13 may implement mutual communication through an internal interface.

According to an embodiment of the present application, a computer-readable storage medium is provided for storing computer programs. When executed by the processor, the programs implement any of the methods according to above embodiments.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process, The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions), For the purposes of this specification, a “computer-readable medium” may be any device that may contain, store, communicate, propagate, or transport the program for use by or in connection with the instruction execution system, device, or apparatus. The computer readable medium of the embodiments of the present application may be a computer readable signal medium or a computer readable storage medium or any combination of the above. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically obtain the program, which is then stored in a computer memory,

It should be understood various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A method for optimizing an Advertisement Click-Through Rate (Ad CTR) estimation model, comprising:
calculating a direction vector and a step vector based on data in a training set, wherein both of the direction vector and the step vector are associated with a first parameter vector, and the first parameter vector is a parameter vector of the Ad CTR estimation model;
calculating an optimized first parameter vector by setting the first parameter vector, the direction vector and the step vector as inputs of an update function, and by using a second parameter vector, wherein the second parameter vector is a parameter vector of the update function;
estimating an optimized second parameter vector according to an optimization target in a validation set, wherein the optimization target is determined by using the optimized first parameter vector; and
updating the optimized first parameter vector by using the optimized second parameter vector.

2. The method according to claim 1, wherein the calculating a direction vector and a step vector based on data in a training set comprising:
calculating elements of the direction vector with a following formula, and forming the direction vector by the calculated elements;
$$d ( {w}_{i}^{t} ) = log \frac{α + click ( {x}_{i} )}{α + predict ( {x}_{i} )} ,$$
wherein
d(wᵢ^{t}) represents an i-th element of the direction vector in a t-th round optimization;
α is a positive number larger than 0 and less than 1;
xᵢ represents an i-th feature of a feature vector of the Ad CTR estimation model;
click (xᵢ) represents an actual click number of the xᵢ in the training set; and
predict(xᵢ) represents an estimated click number of the xᵢ.

3. The method according to claim 1, wherein the calculating a direction vector and a step vector based on data in a training set comprising:
calculating elements of the step vector with a following formula, and forming the step vector by the calculated elements;)
s(wᵢ^{t})=(βimpression(xᵢ)), wherein
s(wᵢ^{t}) represents an i-th element of the step vector in a t-th round optimization;
β is a positive number larger than 0 and less than 1;
xᵢ represents an i-th feature of a feature vector of the Ad CTR estimation model; and
impression(xᵢ) represents a number of times that the xᵢ is presented in the training set.

4. The method according to claim 1, wherein the update function is defined by a following formula:
w^{t+1}+F(w^{t}, d(w^{t}), s(w^{t})), wherein
w^{t+1} represents the optimized first parameter vector in a t-th round optimization;
w^{t} represents the first parameter vector in the t-th round optimization;
d(w^{t}) represents the direction vector associated with the w^{t} in the t-th round optimization; and
s(w^{t}) represents the step vector associated with the w^{t} in the t-th round optimization.

5. The method according to claim 4, wherein the w^{t+1} is determined by:
calculating elements of the w^{t+1} with a following formula, and forming the w^{t+1} by the calculated elements;
w_{j,m}^{t+1}=F(w_{j,m}^{t}, d(w_{j,m}^{t}), s(w_{j,m}^{t}))=w_{j,m}^{t}+uⱼ·vⱼ, wherein
w_{j,m}^{t+1} represents an m-th element in a j-th slot of w^{t+1};
w_{j,m}^{t} represent an m-th element in a j-th slot of w^{t};
d(w_{j,m}^{t}) represents an m-th element in a j-th slot of d(w^{t});
s(w_{j,m}^{t}) represents an m-th element in a j-th slot of s(w^{t});
uⱼ represents a vector associated with a j-th slot in the second parameter vector; and
v₁ represents an eigenvector of a j-th slot.

6. The method according to claim 5, wherein the vⱼ is determined by:
representing each element associated with a j-th slot in the first parameter vector by a three-dimensional vector (w_{j,m}^{t}, d(w_{j,m}^{t}), s(w_{j,m}^{t}), wherein m is an index of the element in the j-th slot:
performing a clustering on the three-dimensional vector of the element associated with the j-th slot via a K-means algorithm, to obtain 1 central points for the j-th slot, wherein the 1 is an integer;
calculating reciprocals of the distances between the three-dimensional vector of the element associated with the j-th slot and the 1 central points for the j-th slot respectively, and setting the reciprocals as elements of the vⱼ; and
forming the vⱼ by the elements.

7. The method according to claim 5, wherein the vⱼ is determined by:
representing a j-th slot of the first parameter vector by a set of three-dimensional vectors (wⱼ^{t}, d(wⱼ^{t}), s(wⱼ^{t})), wherein the wⱼ^{t} is a vector associated with a j-th slot of the w^{t}, the d(wⱼ^{t}) is a vector associated with a j-th slot of the d(w^{t}), and the s(wⱼ^{t}) is a vector associated with a j-th slot of the s(w^{t}); and
re-representing the set of three-dimensional vectors through a Gauss mixture model, and estimating the vⱼ in a maximum expectation algorithm.

8. The method according to claim 1, wherein the training set and the validation set are determined by:
dividing dynamically streaming data with a sliding window, to obtain the training set and the verification set.

9. An apparatus for optimizing an Ad CTR estimation model, comprising:
one or more processors; and
a memory for storing one or more programs, wherein
the one or more programs are executed by the one or more processors to enable the one or more processors to:
calculate a direction vector and a step vector based on data in a training set, wherein both of the direction vector and the step vector are associated with a first parameter vector, and the first parameter vector is a parameter vector of the Ad CTR estimation model;
calculate an optimized first parameter vector by setting the first parameter vector, the direction vector and the step vector as inputs of an update function, and by using a second parameter vector, wherein the second parameter vector is a parameter vector of the update function;
estimate an optimized second parameter vector according to an optimization target in a validation set, wherein the optimization target is determined by using the optimized first parameter vector; and
update the optimized first parameter vector by using the optimized second parameter vector.

10. The apparatus according to claim 9, wherein the one or more programs are executed by the one or more processors to enable the one or more processors to:
calculate elements of the direction vector with a following formula, and form the direction vector by the calculated elements;
$$d ( {w}_{i}^{t} ) = log \frac{α + click ( {x}_{i} )}{α + predict ( {x}_{i} )} ,$$
wherein
d(wᵢ^{t}) represents an i-th element of the direction vector in a t-th round optimization;
α is a positive number larger than 0 and less than 1;
xᵢ represents an i-th feature of a feature vector of the Ad CTR estimation model;
click(xᵢ) represents an actual click number of the xᵢ in the training set; and
predict(xᵢ) represents an estimated click number of the xᵢ.

11. The apparatus according to claim 9, wherein the one or more programs are executed by the one or more processors to enable the one or more processors to:
calculate elements of the step vector with a following formula, and form the step vector by the calculated elements;
s(wᵢ^{t})=log(β+impression(xᵢ)), wherein
s(wᵢ^{t}) represents an i-th element of the step vector in a t-th round optimization;
β is a positive number larger than 0 and less than 1;
xᵢ represents an i-th feature of a feature vector of the Ad CTR estimation model; and
impression(xᵢ) represents a number of times that the xᵢ is presented in the training set.

12. The apparatus according to claim 9, wherein the update function is defined by a following formula:
w^{t+1}=F(w^{t}, d(w^{t}), s(w^{t})), wherein
w^{t+1} represents the optimized first parameter vector in a t-tip round optimization;
w^{t} represents the first parameter vector in the t-th round optimization;
d(w^{t}) represents the direction vector associated with the w^{t} in the t-th round optimization; and
s(w^{t}) represents the step vector associated with the w^{t} in the t-th round optimization.

13. The apparatus according to claim 12, wherein the one or more programs are executed by the one or more processors to enable the one or more processors to calculate elements of the w^{t+1} with a following formula, and form the w^{t+1} by the calculated elements;
w_{j,m}^{t+1}=F(w_{j,m}^{t}, d(w_{j,m}^{t}), s(w_{j,m}^{t}))=w_{j,m}^{t}+uⱼ·vⱼ, wherein
w_{j,m}^{t-1} represents an m-th element in a j-th slot of w^{t+1};
w_{j,m}^{t} represents an m-th element in a j-th slot of w^{t};
d(w_{j,m}^{t}) represents an m-th element in a j-th slot of d(w^{t});
s(w_{j,m}^{t}) represents an m-th element in a j-th slot of s(w^{t});
uⱼ represents a vector associated with a j-th slot in the second parameter vector; and
v₁ represents an eigenvector of a j-th slot.

14. The apparatus according to claim 13, wherein the vⱼ is determined by:
representing each element associated with a j-th slot in the first parameter vector by a three-dimensional vector (w_{j,m}^{t}, d(w_{j,m}^{t}), s(w_{j,m}^{t})), wherein m is an index of the element in the j-th slot;
performing a clustering on the three-dimensional vector of the element associated with the j-th slot via a K-means algorithm, to obtain 1 central points for the j-th slot, wherein the 1 is an integer;
calculating reciprocals of the distances between the three-dimensional vector of the element associated with the j-th slot and the 1 central points for the j-th slot respectively, and setting the reciprocals as elements of the vⱼ; and
forming the vⱼ by the elements.

15. The apparatus according to claim 13, wherein the vⱼ is determined by:
representing a j-th slot of the first parameter vector by a set of three-dimensional vectors (wⱼ^{t}, d(wⱼ^{t}), s(wⱼ^{t})), wherein the wⱼ^{t} is a vector associated with a j-th slot of the w^{t}, the d(wⱼ^{t}) is a vector associated with a j-th slot of the d(w^{t}), and the s(wⱼ^{t}) is a vector associated with a j-th slot of the s(w^{t}); and
re-representing the set of three-dimensional vectors through a Gauss mixture model, and estimating the vⱼ in a maximum expectation algorithm.

16. The apparatus according to claim 9, wherein the one or more programs are executed by the one or more processors to enable the one or more processors to:
divide dynamically streaming data with a sliding window, to obtain the training set and the verification set.

17. Anon-transitory computer-readable storage medium, in which a computer program is stored, wherein the computer program, when executed by a processor, causes the processor to implement the method of claim 1.
